(19) United States
(12) Patent Application Publication
(10) Pub. No.: US 2020/0047208 A1
(43) Pub. Date: Feb. 13, 2020

(54) LIDAR SYSTEM FOR PROPER AEROSOLIZATION OF CROPS

(71) Applicant: Research Foundation of the City University of New York, New York, NY (US)

(72) Inventors: Morann Sonia Dagan, New York, NY (US); Fred Moshary, New York, NY (US); Mark Arend, New York, NY (US)

(21) Appl. No.: 16/539,055

(22) Filed: Aug. 13, 2019

Related U.S. Application Data
(60) Provisional application No. 62/718,010, filed on Aug. 13, 2018.

(51) Int. Cl. B05B 12/08; G01S 17/89; B05B 13/00; A01C 21/00; A01M 7/00

(52) U.S. Cl. CPC B05B 12/082; G01S 17/89; A01M 7/0014; A01C 21/00; B05B 13/005

(57) ABSTRACT

A LIDAR system is used to 3D image an aerosol plume that is being applied to vegetation. The digital map is updated in real-time based on current LIDAR data. The application of the aerosol plume is continually adjusted to keep the aerosol plume within a predetermined location.

### CROSS-REFERENCE TO RELATED APPLICATIONS

This application claims priority to and is a non-provisional of U.S. Patent Application 62/718,010 (filed Aug. 13, 2018), the entirety of which is incorporated herein by reference.

### STATEMENT OF FEDERALLY SPONSORED RESEARCH OR DEVELOPMENT

This invention was made with government support under grant numbers EEC-0540832 and IIP-1745769 awarded by the National Science Foundation. The government has certain rights in the invention.

### BACKGROUND OF THE INVENTION

Atmospheric aerosols are solid or liquid particles suspended in air with varying chemical composition and size ranging from 0.001 μm to 100 μm. These particles can originate from natural sources, such as volcanic eruptions, forest or brush fires, pollen, or sea salt. Particle formation may also arise from human activities, such as the burning of fossil fuels as well as various industrial and agricultural processes. There are two ways in which aerosols enter the atmosphere. They can be emitted or injected directly as particles and are called primary aerosols. Aerosols can also be formed in the atmosphere by in situ aggregation or nucleation from gas phase molecules (gas-to-particle conversion process) and are termed secondary aerosols.

Atmospheric aerosols greatly impact air quality and significantly contribute to a negative effect in human health. Over several decades, an enormous amount of data has been collected by many scientists establishing a link between air pollution and mortality rates. High concentrations and long exposures of particulate matter (PM) have both been associated with numerous chronic illnesses. After episodes of acute exposure to high concentrations of atmospheric aerosols, such as the great smog of 1952 in London, chronic health problems and resultant death are an evidential result to PM exposure. Further studies have indicated that long exposure to ambient atmospheric aerosol concentrations can exacerbate an existing disease or cause a chronic illness. This subjection to atmospheric aerosols has been linked to lung cancers and cardiopulmonary syndromes. Such results from numerous studies designate the need to understand aerosol properties such as particle size, composition, and source information in order to model the effects of pollution on human health.

Inefficient agricultural pesticide spraying causes aerosol drift which can lead to crop damage or illegal pesticide use in neighboring, non-target crop areas. It may contaminate nearby bodies of water or be an issue for human health. Inefficiency of sprayers are due to several factors; lack of continuous and proper calibration, turning certain nozzles on or off and adjusting their direction based on canopy height, correcting spray pressure based on canopy density, understanding wind conditions and direction of plume drift due to the wind. All of these factors can be greatly or completely reduced with the use of the disclosed device. This may be done through monitoring drift of spray materials in real time during each application and tracking the amount of spray that reaches the canopy.

Airblast sprayers are highly inefficient and waste about 45% of the chemicals emitted from the nozzles. Those chemicals either deposit on the ground and cause contamination or pollute the air. Aerial spraying is also prone to high levels of drift. Several studies have found drift at hundreds and even thousands of meters away from the target depending on the atmospheric conditions, droplet size and material sprayed. The disclosed device saves a significant amount on chemical losses and reduces drift of chemicals onto neighboring farms, public roads, or non-agricultural areas. Other than the environmental (and related liability protection) benefits, farmers will benefit from such a device through reduced costs of wasted materials resulting from over-spraying, while feeling safe against pest and fungus infestation resulting from under-spraying.

An improved method for controlling the spray application is therefore desired.

The discussion above is merely provided for general background information and is not intended to be used as an aid in determining the scope of the claimed subject matter.

### SUMMARY

A LIDAR system is used to 3D image an aerosol plume that is being applied to vegetation. The digital map is updated in real-time based on current LIDAR data. Mapping the spray application provides information on which canopy rows a vehicle must traverse to apply the chemical; if a row needs reapplication due to drift or if a row should be skipped due to drift. The application of the aerosol plume is continually adjusted to keep the aerosol plume within a predetermined location.

In a first embodiment, a method for aerosolizing vegetation is provided. The method comprising steps of: digitally mapping an aerosol plume that is being applied to vegetation, thereby producing a digital map, the mapping occurring using a Light Detection and Ranging (LIDAR), the aerosol plume being applied with a vehicle comprising: a tank holding a liquid; a spray nozzle for aerosolizing the liquid thereby producing the aerosol plume, the spray nozzle being mounted on a rotating base configured to control pitch and yaw of the spray nozzle; a fluid pump for pumping the liquid from the tank to the spray nozzle at a flow rate; a first wireless communication device; a computer processor configured to control the rotating base and selectively actuating the spray nozzle; wherein the LIDAR is disposed at a distance of at least 15 meters from the vehicle throughout the method; updating, in real-time, the digital map of the aerosol plume based on wireless data received from the LIDAR, thereby producing an updated digital map; adjusting the application of the aerosol plume based on the updated digital map such that the aerosol plume is applied within a predetermined location corresponding to the vegetation, the step of adjusting comprising at least one of adjusting the pitch of the spray nozzle; adjusting the yaw of the spray nozzle and adjusting the flow rate of the fluid pump.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 is a schematic diagram showing one method for applying an aerosol to vegetation while monitoring with lidar;

FIG. 2 is a schematic depiction of one vehicle for use with the method;

FIG. 3 is a schematic diagram showing the components of an exemplary lidar;

FIG. 4A is an aerial view of a vehicle applying an aerosol to vegetation with the vehicle in a first position;

FIG. 4B is an aerial view of a vehicle applying an aerosol to vegetation with the vehicle in a second position;

FIG. 4C is an aerial view of a vehicle applying an aerosol to vegetation with the vehicle in a third position;

FIG. 4D is an aerial view of a vehicle applying an aerosol to vegetation with the vehicle in a fourth position;

FIG. 4E is an aerial view of a vehicle applying an aerosol to vegetation with the vehicle in a fifth position.

### DETAILED DESCRIPTION OF THE INVENTION

LiDAR is an acronym for Light Detection and Ranging and is applied in the field of optical remote sensing to study the atmosphere. A LiDAR device, often referred to simply as a ‘lidar’, directs a laser beam towards the atmosphere, in which the beam is scattered by atmospheric molecules or particles. A receiver collects the portion of the laser light backscattered towards the receiver. A lidar has the following basic subsystems: (1) a pulsed laser source, (2) a receiver, which collects the backscattered light and converts it into an electrical signal, and (3) a data acquisition system, which digitizes the electrical signal as a function of time or range and records the data. A laser pulse is emitted into the atmosphere, and the light backscattered by atmospheric particles and molecules is collected by a telescope and focused on a light detector. The resulting signal is then recorded by the data acquisition system.

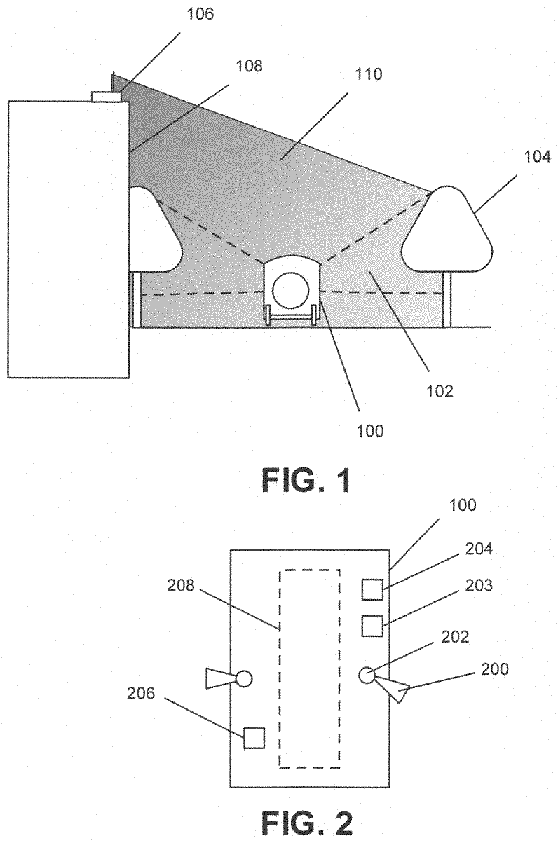

FIG. 1 depicts a vehicle 100 that sprays an aerosol plume 102 on vegetation 104. The vehicle 100 may be any suitable vehicle, aerial or ground based, such as a human-operated vehicle, computer-operated farm equipment, a plane or a drone. The aerosol plume 102 may be, for example, an herbicide, a pesticide, a fertilizer or other suitable aerosols. A lidar 106 is disposed on a nearby structure 108 which may be, for example, a building such as a tower. The remote placement of the lidar 106 permits measuring the aerosol remotely and avoiding the corrosive environment during spraying applications. The lidar 106 emits light 110 that is directed downward toward the vegetation 104. In one embodiment, the lidar 106 is disposed at least 15 meters and no more than 5 km from the vehicle 100.

FIG. 2 depicts a schematic of a top view of the vehicle 100. The vehicle 100 comprises at least one spray nozzle 200 that is mounted on a rotating base 202. The rotating base 202 is controlled by a wireless communication device 204 that is connected to a computer processor 203 such that the spray nozzle 200 can be rotated with regard to pitch, roll and yaw. In one embodiment, the rotating base 202 is also attached to an extendable pole that can raise or lower the rotating base 202 vertically. A fluid pump 206 pumps fluid (e.g. a fertilizer, etc.) in tank 208 to the spray nozzle 202. The fluid pump 206 is also controlled by the computer processor.

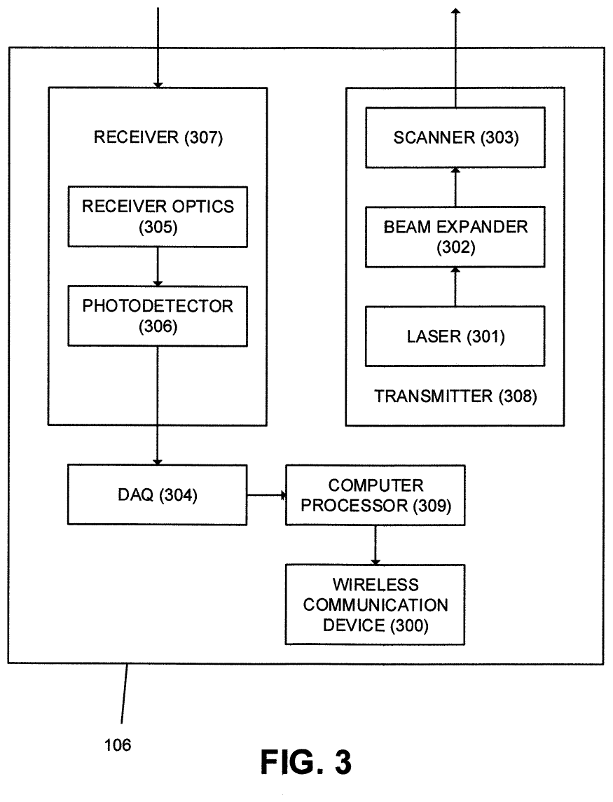

FIG. 3 is a schematic depiction of the lidar 106. The lidar 106 comprises a receiver 307 and a transmitter 308. The transmitter 308 comprises a laser 301, a beam expander 302 and a scanner 303. The laser 301 may be a fiber laser or a semiconductor laser. The laser 301 has a higher average power and higher repetition rate than conventional lasers. The average power emitted by the laser 301 is between 10 mW and 1000 mW and the repetition rate is between 100 Hz and 100 kHz. The laser 301 is a pulsed laser with a pulse length between 1 and 100 ns. The result is a high repetition rate data acquisition system 304, DAQ, with a minimum sampling rate of 10 MS/s. A scanner 303 directs the laser in a variety of directions for scanning in one or two dimensions in space.

Creating an eye-safe micropulse lidar is accomplished by limiting the amount of laser energy per unit area. Therefore, the cross-sectional area of the beam is expanded until eye-safe irradiance is achieved. Beam expander 302 specifications were sought out to expand the beam enough to achieve laser eye safety regulations, while limiting the beam divergence to optimize signal acquisition.

The receiver 307 incorporates receiver optics 305 and a photodetector 306 with high sensitivity and low noise for measuring airborne drift and vapor drift over a scanned area. The receiver optics 305 can either be coaxial or biaxial to achieve drift measurements. An optical filter is incorporated in the receiver optics 305 in order to minimize the effects of background light.

The lidar 106 provides actionable information in real-time acquired from the lidar 106 in a format that is tailored to the hardware that controls the computer processor 203 of the vehicle 100 via the wireless communication device 204 and thereby the spray nozzle 202. By continuously monitoring the density of the aerosol plume 102 the spraying can be controlled. For example, the pitch, roll and yaw of the rotating base 202 can be controlled to direct the resulting aerosol. The volume of the aerosol plume 102 and the distance of the aerosol plume 102 can be controlled by controlling the fluid pump 206.

Referring again to FIG. 3, a wireless communication device 300 with a computer processor 309 is shown that processes data from the lidar 106 to produce a two-dimensional (2-D) or three-dimensional (3D) map of the aerosol plume 102 that is produced from the vehicle 100. The computer processor 309 includes parameters for a target aerosol distribution. For example, the parameters can include a predetermined volume of space that most (e.g. at least 80%) of the aerosol plume 102 should be contained within. If the aerosol plume 102 is exceeding those parameters, then the computer processor 309 sends a wireless signal to the wireless communication device 204 and adjusts the fluid pump 206 and/or the rotating base 202 to cause the aerosol plume 102 to remain within the parameters. For example, if the wind is blowing the aerosol plume 102 in an undesired direction, the computer processor 203 may rotate the rotating base 202 to counteract the effect of the wind. The data collected by the disclosed system determines the overall plume size and shape as well as the application efficiency. Furthermore, it provides 3D mapping of the crop field. This provides valuable information on the growth and health of the crop over time. In one embodiment, the vehicle 100 is a computer-controlled vehicle such that the computer processor controls the vehicle function (e.g. start, stop, forward rate of travel, reverse rate of travel, turning, etc.). The vehicle includes a means for moving such as wheels or tractor treads. In another embodiment, the vehicle 100 is a human-controlled vehicle such that the human controls the vehicle function and the computer processor 203 controls the application of the aerosol plume 102.

The disclosed device is an eye-safe lidar for detection of pesticide, fungicide or other agricultural spray. The lidar system performs in variable outdoor environments in changing temperatures and humidity levels for extended periods of time. The transmitter is eye-safe and invisible, allowing it to be deployed in a wide range of locations, including the vicinity of a heavy air-traffic areas as it will not interfere with a pilot's operation of an aircraft. The system scans in one dimension (e.g. positive and negative directions along an x axis) to provide a 2D image or in two dimensions (e.g. positive and negative directions along both an x axis and a y axis) to yield a 3D image of an aerosol plume shape (such as pesticide plume from spray nozzles). A sensitive receiver, with a low Noise-Equivalent Power (NEP) and a high responsivity, detects the signal and directs it to a data acquisition system (DAQ) 304. A computer processor analyzes the data (point cloud imagery) and can produce a number of tailored reports. A passive visible imager, such as an RGB (Red Green Blue) camera, is also included to provide visual context to the lidar imagery as well as crop color detection (e.g. NDVI, Normalized Difference Vegetation Index) for crop health analysis.

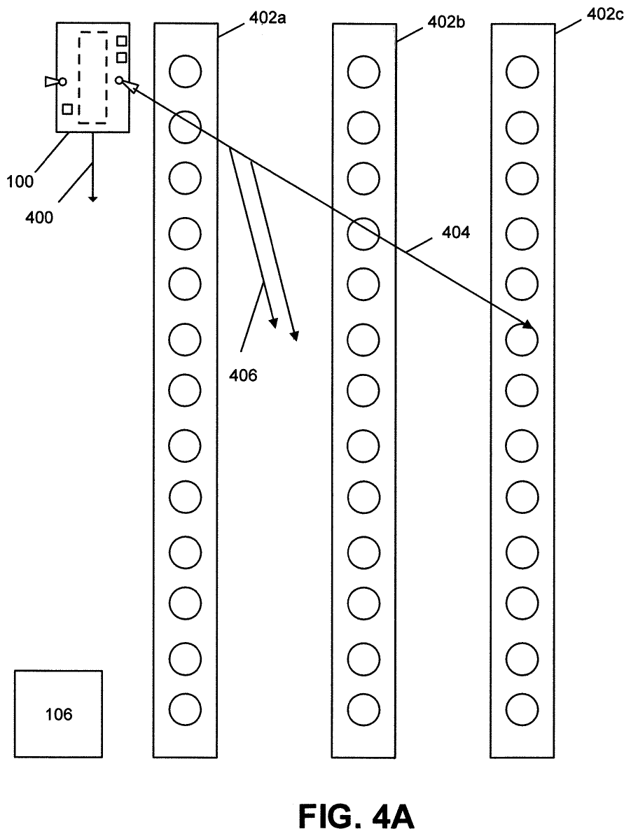

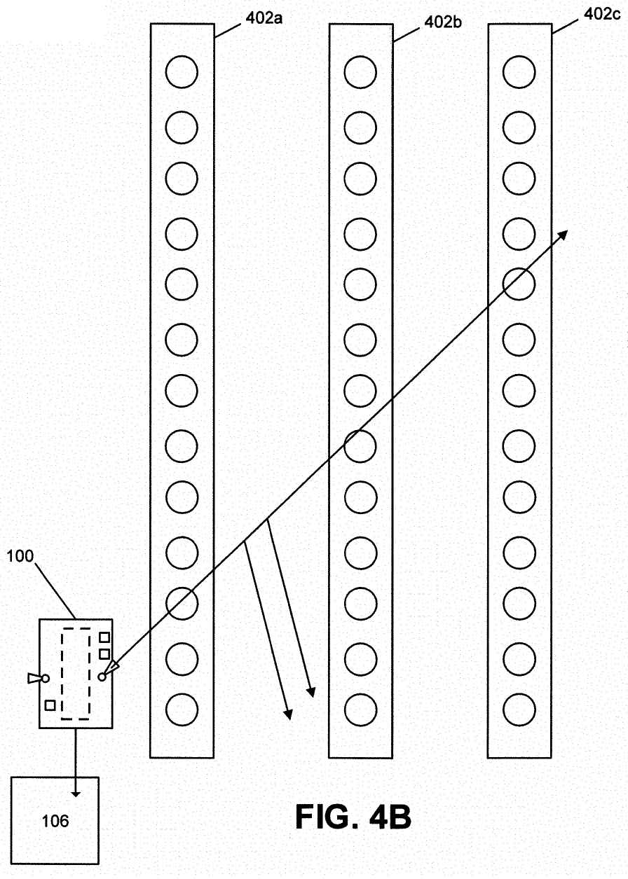

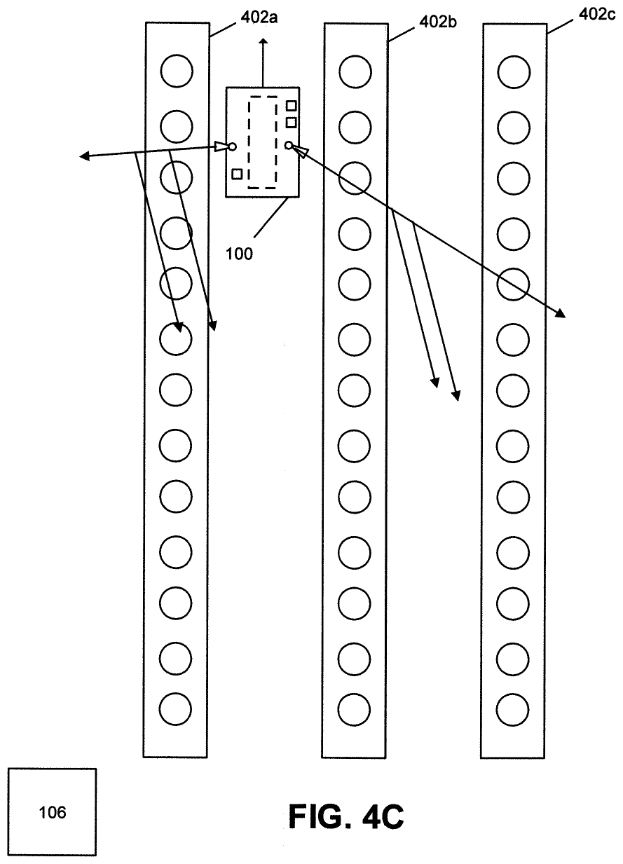

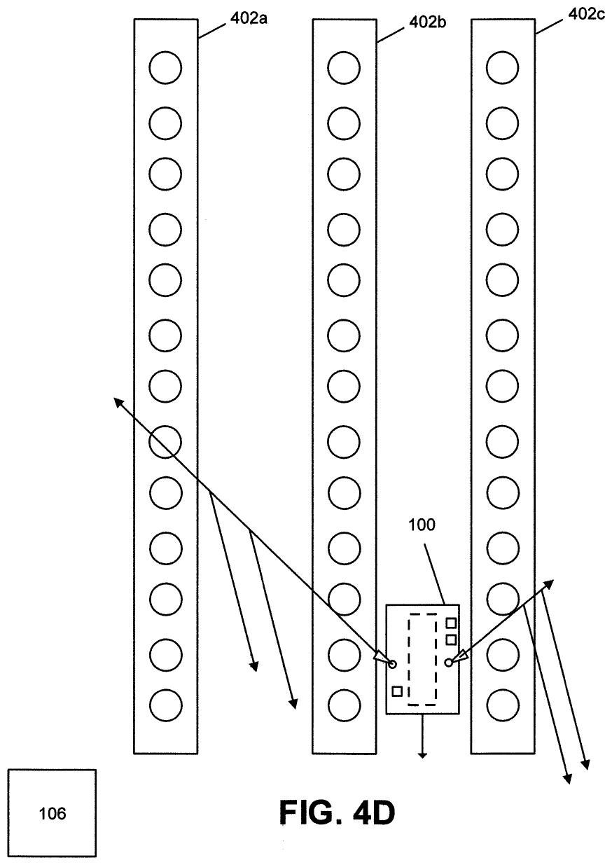

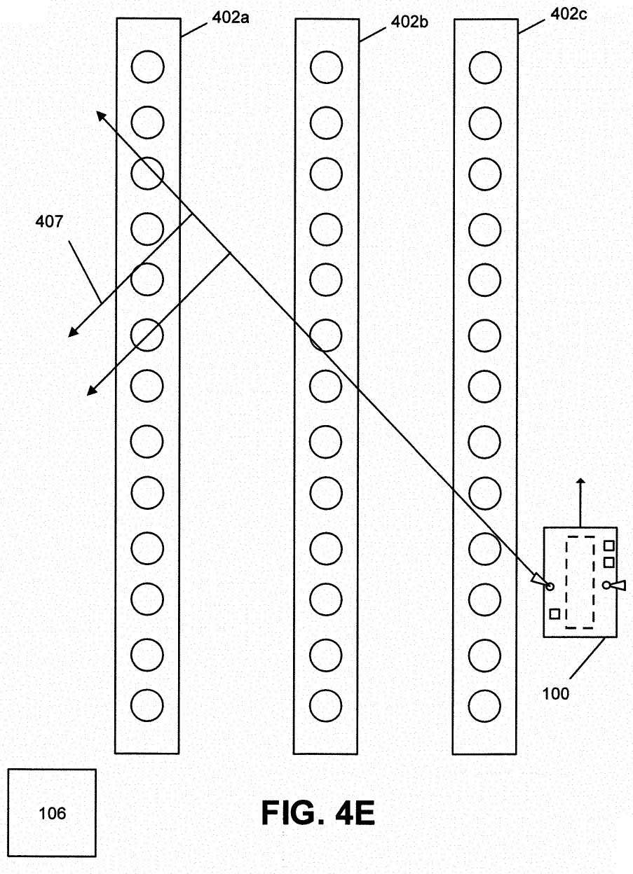

FIG. 4A provides an example of the system in use. The vehicle 100 is moving in direction 400 among rows 402a, 402b and 402c of vegetation. One of the spray nozzles emits an aerosol in the direction of arrow 404. The winds 406 alter the distribution of the aerosol. Lidar 106 maps the current distribution of the aerosol in 2D or 3D. The computer processor 309 in the lidar 106 wirelessly communicates with the computer processor 203 in the vehicle 100 to control both the movement of the vehicle and the operation of the spray nozzle(s).

FIG. 4B shows the vehicle 100 as it approaches the end of row 402a. The spray nozzle is rotated to ensure the aerosol is not being sprayed outside of row 402a. The trajectory of the aerosol is chosen to include the effect of the winds 406. In both FIG. 4A and FIG. 4B show the fluid pump providing the aerosol with a pressure that distributes the aerosol over rows 402a, 402b and 402c. Because the lidar 106 is monitoring the position of the aerosol in real-time the fluid pumps, spray nozzle(s) and vehicle 100 can all be rapidly adjusted for changing environmental conditions, such as the current winds.

FIG. 4C shows the vehicle 100 as it approaches the end of rows 402a, 402b. In FIG. 4C, the vehicle 100 is between rows 402a and 402b. Accordingly, spray nozzles on both sides of the vehicle 100 are actuated. One spray nozzle is actuated with a pressure that distributes the aerosol over row 402a. The other spray nozzle is actuated with a higher pressure that distributes the aerosol over row 402b and 402c. The trajectory of each of the aerosols is independently chosen to include the effect of the winds 406.

FIG. 4D shows the vehicle 100 as it approaches the end of rows 402b, 402c. In FIG. 4D the vehicle 100 is between rows 402b and 402c. Accordingly, spray nozzles on both sides of the vehicle 100 are actuated. One spray nozzle is actuated with a pressure that distributes the aerosol over row 402c. The other spray nozzle is actuated with a higher pressure that distributes the aerosol over row 402a and 402b. The trajectory of each of the aerosols is independently chosen to include the effect of the winds 406.

FIG. 4E shows the vehicle 100 as it begins row 402c. Because all of the rows 42a, 402b and 402c are on the same side of the vehicle, only one spray nozzle is actuated. In the embodiment of FIG. 4E, the winds 407 have changed direction relative to winds 406. The trajectory of each of the aerosol is chosen to include the effect of the winds 407. Each trajectory can be adjusted in real-time as a response to the aerosol position as determined by the lidar 106.

The embodiment of FIGS. 4A-4E depict the spray from a two-dimensional aerial view. One skill in the art, after benefiting from reading this specification, will recognize the spray nozzle controls the spray in three dimensions because the spray nozzle can be controlled in pitch, roll and yaw as well as in its vertical position due to the extension of the extendable pole that holds the spray nozzle.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

In the case where the pressure of the spray cannot be adjusted for individual nozzles, the spray map may be used to adjust the route of the spray applicator to account for drift.

What is claimed is:

1. A method for aerosolizing vegetation, the method comprising steps of:
digitally mapping an aerosol plume that is being applied to vegetation, thereby producing a digital map, the mapping occurring using a Light Detection and Ranging (LIDAR), the aerosol plume being applied with a vehicle comprising:
a tank holding a liquid;
a spray nozzle for aerosolizing the liquid thereby producing the aerosol plume, the spray nozzle being mounted on a rotating base configured to control pitch and yaw of the spray nozzle;
a fluid pump for pumping the liquid from the tank to the spray nozzle at a flow rate;
a first wireless communication device;
a computer processor configured to control the rotating base and selectively actuating the spray nozzle;
wherein the LIDAR is disposed at a distance of at least 15 meters from the vehicle throughout the method;
updating, in real-time, the digital map of the aerosol plume based on wireless data received from the LIDAR, thereby producing an updated digital map;
adjusting the application of the aerosol plume based on the updated digital map such that the aerosol plume is applied within a predetermined location corresponding to the vegetation, the step of adjusting comprising at least one of adjusting the pitch of the spray nozzle; adjusting the yaw of the spray nozzle and adjusting the flow rate of the fluid pump.

2. The method as recited in claim 1, wherein the spray nozzle is mounted on an extendable pole configured to raise and lower the spray nozzle vertically, the extendable pole being controlled by the computer processor.

3. The method as recited in claim 1, wherein the step of adjusting comprises at least two of adjusting the pitch of the spray nozzle; adjusting the yaw of the spray nozzle and adjusting the flow rate of the fluid pump.

4. The method as recited in claim 1, wherein the step of adjusting comprises adjusting the pitch of the spray nozzle; adjusting the yaw of the spray nozzle and adjusting the flow rate of the fluid pump.

5. The method as recited in claim 1, wherein the LIDAR comprises a laser that generates a laser output;
a photo detector;
a beam expander to collimate the laser output from the laser to improve signal acquisition;
a receiver optic;
a data acquisition system (DAQ);
a second wireless communication device for exchanging data with the first wireless communication device.

6. The method as recited in claim 1, wherein the vehicle is a computer-controlled vehicle.

7. The method as recited in claim 1, wherein the computer processor controls the fluid pump.

8. The method as recited in claim 5, wherein the laser has an average power greater than 10 mW.

9. The method as recited in claim 8, wherein the laser has a repetition rate that exceeds 100 Hz.

10. The method as recited in claim 9, wherein the laser has a pulse length between 1 ns and 100 ns.

11. The method as recited in claim 10, wherein the laser has a minimum sampling rate of 10 MS/s.

12. The method as recited in claim 10, wherein the laser is a fiber laser.

13. The method as recited in claim 10, wherein the laser is a semiconductor laser.
